(19) United States
(12) Patent Application Publication
(10) Pub. No.: US 2006/0034492 A1
(43) Pub. Date: Feb. 16, 2006

(54) Hand recognition system

(76) Inventors: Roy Siegel, Portland, OR (US); Willem den Boer, Hillsboro, OR (US); Adiel Abileah, Portland, OR (US)

Correspondence Address: Kevin L. Russell, Suite 1600, 601 SW Second Ave., Portland, OR, 97204-3157, US

(21) Appl. No.: 10/285,464

(22) Filed: Oct. 30, 2002

(51) Int. Cl. G06K 9/00

(52) U.S. Cl. 382/115

(57) ABSTRACT

A hand recognition system.

### BACKGROUND OF THE INVENTION

The present invention relates to verification devices. More particularly, it relates to a verification system which measures the hand of a user for the purposes of verification.

Traditionally, keys of both a mechanical and an electrical nature have been used to restrict access to secure areas to authorized individuals. The controlled access to secure areas may be to physical areas, such as with the common lock and key, or to information, such as with computer terminal passwords, or to valuables, such as with automatic bank teller personal identification codes. One of the problems with these types of systems is that access is provided to any key holder, and the keys are transferable and easily lost, stolen or passed on.

More recently, identification devices relying upon biometric characteristics unique to an individual have been proposed. Such biometric devices measure and compare characteristics of such things as voice, fingerprints, facial scans, retinal scans, and signatures. Each of these biometric devices have performance limitations because the characteristic of the person that is measured tends to vary greatly even for a given individual. For example, a person's fingerprints suffer day-to-day damage from scratches, abrasions and so on, that make accurate automatic identification very difficult. Also, biometric devices tend to be very costly to manufacture because of the precision required for repeatable measurement of such fine detail as fingerprint minutia in fingerprint recognition systems, and high fidelity voice detection and background noise filtering in voice recognition systems.

It is generally known that people's hands differ in their size and shape, and that these differences may be used for verification of an individual's identify. Many geometric characteristics of the hand may be measured and used as the basis to distinguish between different people. For example, one or more measurements such as finger length, knuckle positions, width, area, perimeter, thickness, and so on, may be used for verification of an individual's identify. Also, combinations of these measurements, such as the ratio of length to width, can be used with good effect as identity discriminates. Depending on the particular system design, hand recognition systems are relatively invariant to dirt, ethnicity, age, and imaging quality.

Systems exist that utilize two-dimensional pictures of the hand outline obtained with an electronic digitizing camera. However, they may be defeated by the use of an artifact in the shape of the hand of the claimed identity. Since only a simple two dimensional shadow image is required, such an artifact is easily constructed from a cardboard tracing of the hand of an authorized user. Such an outline can be obtained either surreptitiously, or through the cooperation of the authorized user.

Sidlauskas, U.S. Pat. No. 4,736,203, discloses a three dimensional hand profile identification system. Referring to FIG. 1, Sidlauskas discloses an overall enclosure 10 which houses a digitizing camera 12, optical beam reflecting mirrors 13 and 14, a hand measuring platen 15, a keypad 16 for entering an identity code, suitable control and processing electronics 17, and a comparison results indicating lamp 18. The camera 12 and the mirrors 13 and 14 are positioned within the enclosure 10 such that the camera has a full view of the measuring platen 15. A first measuring surface 20 and a second measuring surface 22 are at right angles with respect to each other, both constructed from a optically retro-reflective material. A plane mirror 24 is mounted to the first measuring surface 20 on the side opposite from the second measurement surface 22 and facing the second measuring surface but tilted at an angle of 45 degrees to both the first measuring surface and the optical axis of the digitizing camera. While the system disclosed by Sidlauskas is functional, the optical system is somewhat complex, and requires a relatively extensive optical path. In addition, the housing and associated electronics are somewhat “industrial” in appearance and not aesthetically suitable for all environments.

### BRIEF DESCRIPTION OF THE DRAWINGS

FIG. 1 illustrates an existing hand recognition system.

FIG. 2 illustrates an exemplary embodiment of a hand recognition system of the present invention.

FIG. 3 illustrates a display with textual and graphical information.

FIG. 4 illustrates a display with textual and graphical information.

FIG. 5 illustrates a display with textual and graphical information.

FIG. 6 illustrates a display with textual and graphical information.

FIG. 7 illustrates an exemplary flow chart for the operation of the system shown in FIG. 2.

FIG. 8 illustrates an exemplary processing block diagram for the system shown in FIG. 2.

FIGS. 9A and 9B illustrates data from the system shown in FIG. 2.

FIG. 10 is a cross sectional view of a traditional active matrix liquid crystal display.

FIG. 11 is a schematic of the thin film transistor array.

FIG. 12 is a layout of the thin film transistor array of FIG. 11.

FIGS. 13A-13H is a set of steps suitable for constructing pixel electrodes and amorphous silicon thin-film transistors.

FIG. 14 illustrates pixel electrodes, color filters, and a black matrix.

FIG. 15 illustrates a schematic of the active matrix elements, pixel electrode, photo TFT, readout TFT, and a black matrix.

FIG. 16 illustrates a pixel electrode, photo TFT, readout TFT, and a black matrix.

FIG. 17 is a layout of a thin film transistor array.

FIG. 18 is a graph of the capacitive charge on the light sensitive elements as a result of inhibiting light to the display at high ambient lighting conditions.

FIG. 19 is a graph of the capacitive charge on the light sensitive elements as a result of inhibiting light to the display at low ambient lighting conditions.

FIG. 20 is a graph of the photo-currents in an amorphous silicon TFT array.

FIG. 21 is a graph of the capacitive charge on the light sensitive elements as a result of inhibiting light to the display.

FIG. 22 is an alternative layout of the pixel electrodes.

FIG. 23 illustrates a timing set for the layout of FIG. 22.

FIG. 24 illustrates even/odd frame addressing.

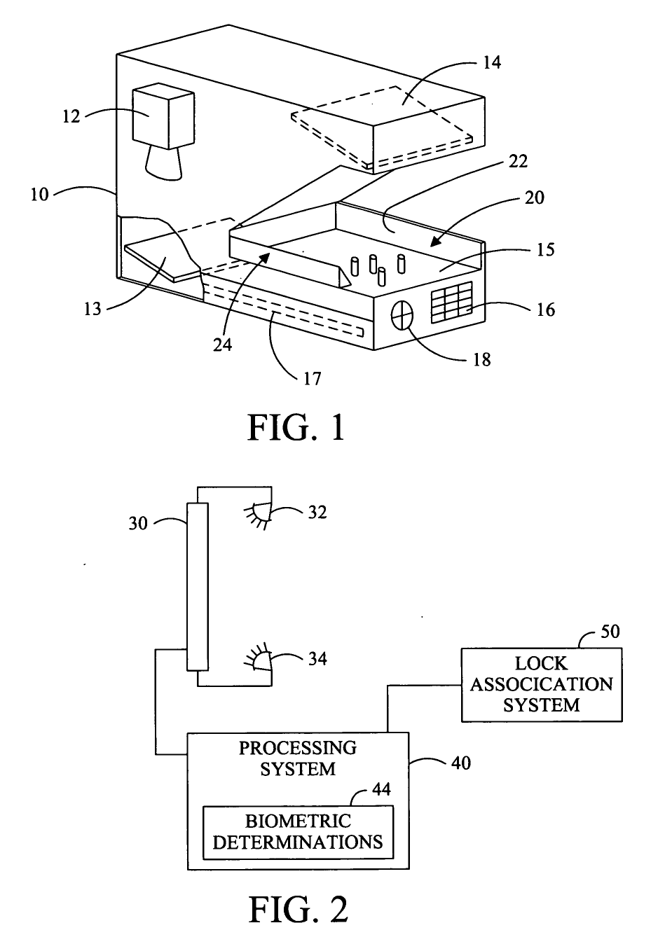

### DETAILED DESCRIPTION OF THE PREFERRED EMBODIMENT

The present inventors considered the aforementioned hand recognition imaging systems and came to the realization that a non-intrusive hand recognition system may include a display, which is capable of displaying still images and/or video images, together with integrated light sensitive elements to detect the presence of the hand of the user, and/or the characteristics of the hand, and/or the shape of the hand, etc., described later. The hand may include any portion of the hand, such as for example, the fingers (e.g., 1-4), the thumb, the palm, lines on the hand, webbing between fingers, knuckle positions, and translucency.

Referring to FIG. 2, the display 30 may be mounted to a wall, sit on a desktop, or any other suitable place. In addition to being used for hand recognition, the display 30 may be used to present text and/or images, such as information regarding use of the hand recognition system, responses to using the hand recognition system, context-relevant information (e.g., welcome, instructions about a situation needing biometric input, advertisements, etc.), advertisements, or any other application. Moreover, the display 30 may be the display of a desktop personal computer system, where the hand recognition system is used for any suitable purpose. Further, the display 30 may be the display of a laptop computer system, stand alone display, network connected display, thin-client computing device with display, where the hand recognition system is used for access and security purposes. When the display 30 is being used for hand recognition a set of light sensitive elements integrated with the display capture an image of the hand or a portion thereof placed in overlying relationship to the display, such as in contact thereto or in the proximity thereof. For example, the light sensitive elements may sense the contrast in the ambient light reaching the light sensitive elements, with those light sensitive elements aligned with the source of ambient light and the hand having a reduced ambient light level with respect to other light sensitive elements.

For purposes of “2-dimensional” imaging the system senses the contrast of the hand outline based upon ambient lighting conditions. One or more external lights (32, 34) may have their light, such as white light, directed toward the display. The additional light directed toward the display, with the hand at least partially between the additional light and the display, will increase the contrast for measurements. In addition, different colored lights may be used, such as red, green, and/or blue lights (or a white light with a color filter output) with corresponding red, green, and/or blue sensors (or a white light sensor with an associated color filter). Having different colored lights positioned at different locations together with different colored sensors will tend to increase the contrast for measurements. Moreover, one or more of the external white lights, and/or one or more of the external different colored lights may be temporally modulated (such as for example, differences in intensity, differences in the color of the output light, on/off changes in intensity) so that the corresponding sensors will detect temporal changes in the sensed light, which likewise may be used to increase contrast.

Additional fraud verification may be based upon ambient lighting conditions. For example, the hand of the user may cast a shadow having different intensities which may be sensed by the sensors. In many cases, the interior portion of the hand will cast a dark shadow (e.g., dark) while the edges of the hand will cast a light shadow (e.g., grayscale). Additional fraud verification may be performed by temporally characterizing the edges and/or shadows (e.g., grayscale) cast onto the display. For example, the system may be able to readily detect a cardboard cutout of a hand that is being fraudulently used by temporal characterization of a excessively thin side profile at some point. In addition, the aforementioned discussion regarding additional lights, grayscale, shadows, temporal analysis, filtered lights, filtered sensors, temporal modulation, etc., may likewise be employed for fraud verification.

In many cases, the verification potential of 2-dimensional processing may be limited. If desired, the system may include 3-dimensional processing of the characteristics of the hand to potentially increase the verification accuracy, frequently by processing a plurality of frames. For example, thickness estimates of the hand of the user may be made using any of the aforementioned techniques, including for example, the temporal based shadows from external white or colored light. A light sensitive display may be oriented on the side of the display 30, if desired.

A processing system 40 included within the display 30, separate from the display 30, or partially within the display 30 and partially separate from the display 30, may be used for obtaining and processing data from the light sensitive elements. In many cases, the data from the light sensitive elements will be obtained in a scanning operation in a row-by-row manner. The data from the light sensitive elements may be converted to an equivalent bit-mapped image, if desired. The processing system 40 may likewise include a biometric determination process 44 which processes the data from the light sensitive elements of the display 30 to determine whether the hand or portion thereof is identified. If the hand being sensed is identified, such as by template matching, the processing system 40 may unlock or otherwise permit access to any associated system 50. The permitting access is intended to broadly include any resulting activity or action, such as for example, retail, e-commerce, financial transactions, signing up for an activity or program. In many cases, the resulting event is something that would not have otherwise been permitted had the biometric verification been successful. The template matching is intended to include any and all techniques, whether including a formal “template” or not, for comparing hand related information (e.g., data) to other hand related information (e.g., data).

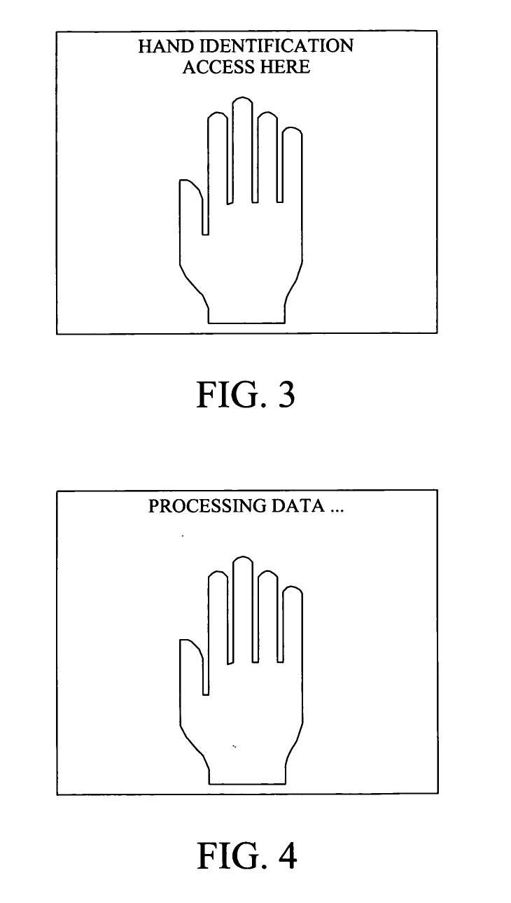

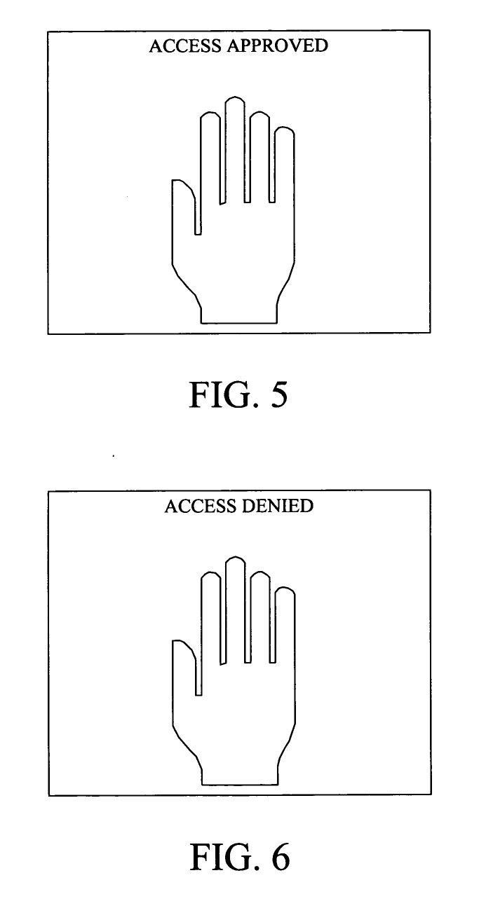

Referring to FIG. 3, during the process of hand identification, the display 30 may provide textual or graphical indication that the display provides hand identification and where to locate the hand. Referring to FIG. 4, during the processing of the data from the light sensitive elements, the display may provide an indication that the processing is being performed. Referring to FIG. 5, if the hand is identified then the system may indicate that access is approved, or otherwise denied, as illustrated in FIG. 6. In this manner, the display may provide the interactive feedback with the user without the need for additional light or sound indications, which may be misunderstood by the user. Moreover, if the wrong hand is used (in the case of a right hand and left hand sensitive system), the hand is not sufficiently close to the display, the fingers are not sufficiently separated, etc., then appropriate messages may be displayed on the display to assist the user. The graphical and textual display indications may likewise be used with other hand sensing systems that are proximate the display.

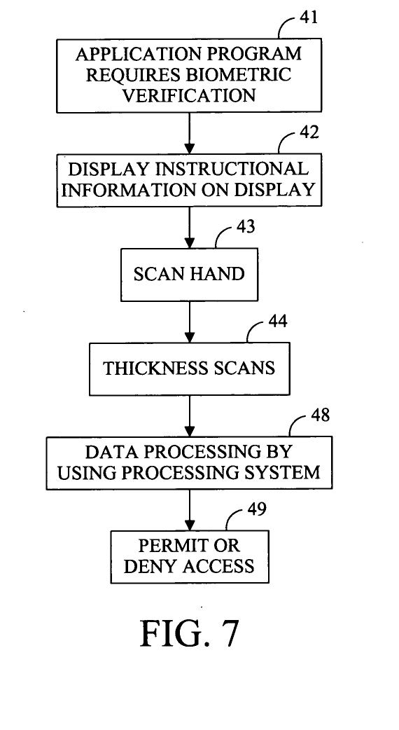

Referring to FIG. 7, merely by way of illustration, the following steps may be used by the system for hand identification. An application program running on the processing system 40 requires biometric verification, for any suitable application, such as for example, computer log-in, network log-in, file access, physical access, e-commerce, security, etc., at block 41. The application program displays suitable instructional information on the display 30, including for example, an outline of a hand to show the user where to put his hand, at block 42. The processing system 40 provides a command to the display 30 to scan the hand or otherwise scans the hand, at block 43. The scanning may involve creating one or more 2-dimensional bitmaps, turning on and off other light sources, reading values from light sensitive elements, testing the sufficiency of the data, averaging multiple scans (reduces signal to noise ratio), and/or creating differential measurements by obtaining scans with and without the optional lights being turned on. The system may optionally perform thickness scans at block 44 by turning on a light source positioned during scanning of block 43, such that modified shadows are created as a function of the thickness of the hand. Block 43 may be repeated for different lights, light combinations, and/or different colors.

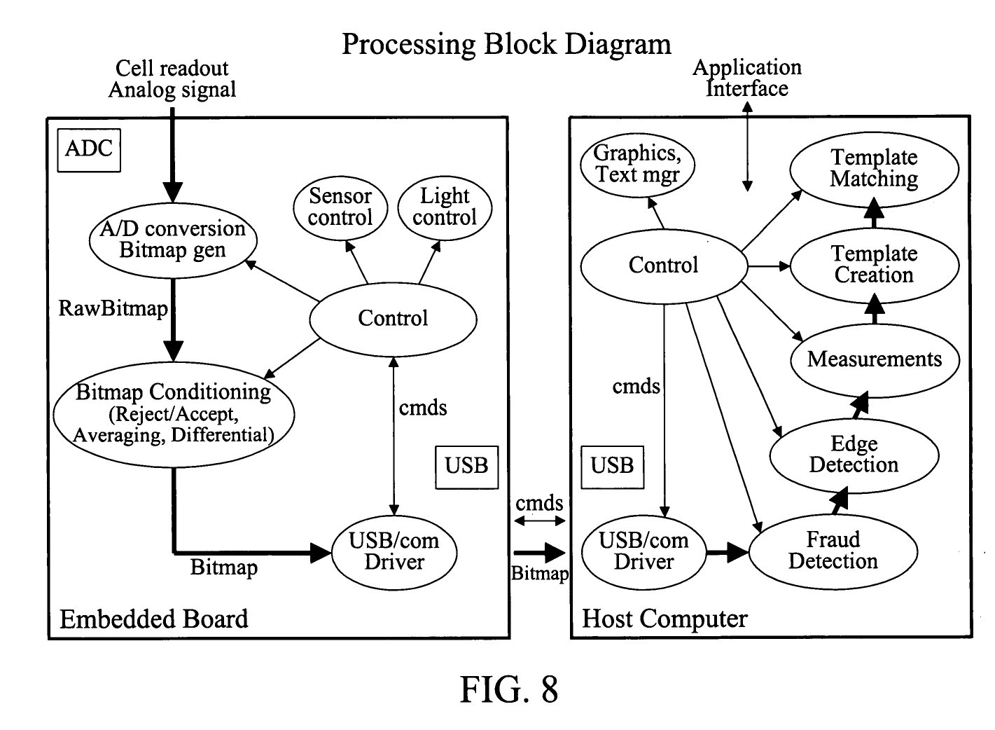

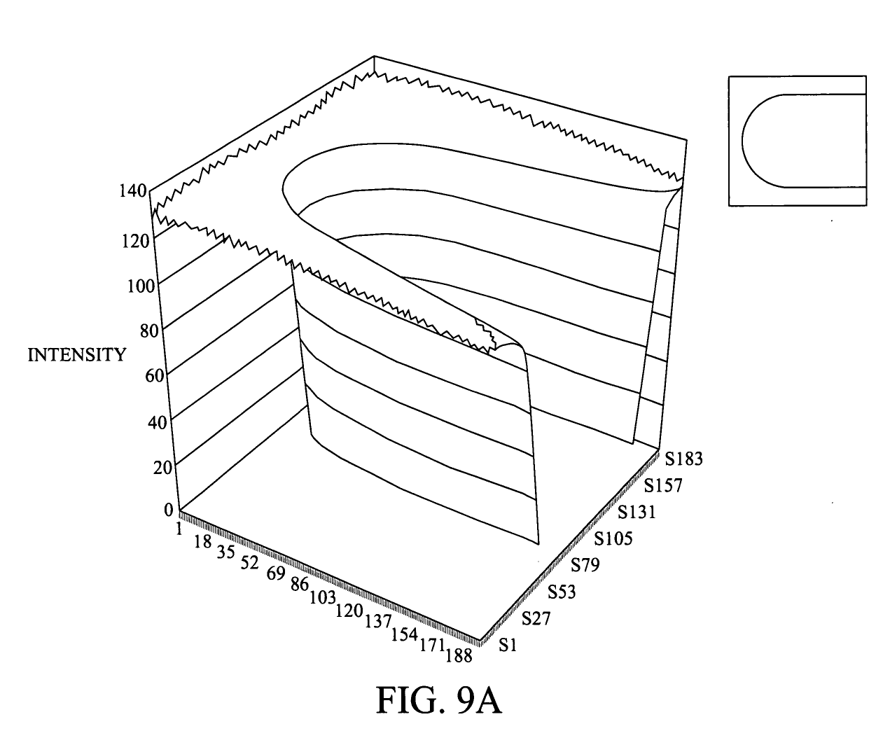

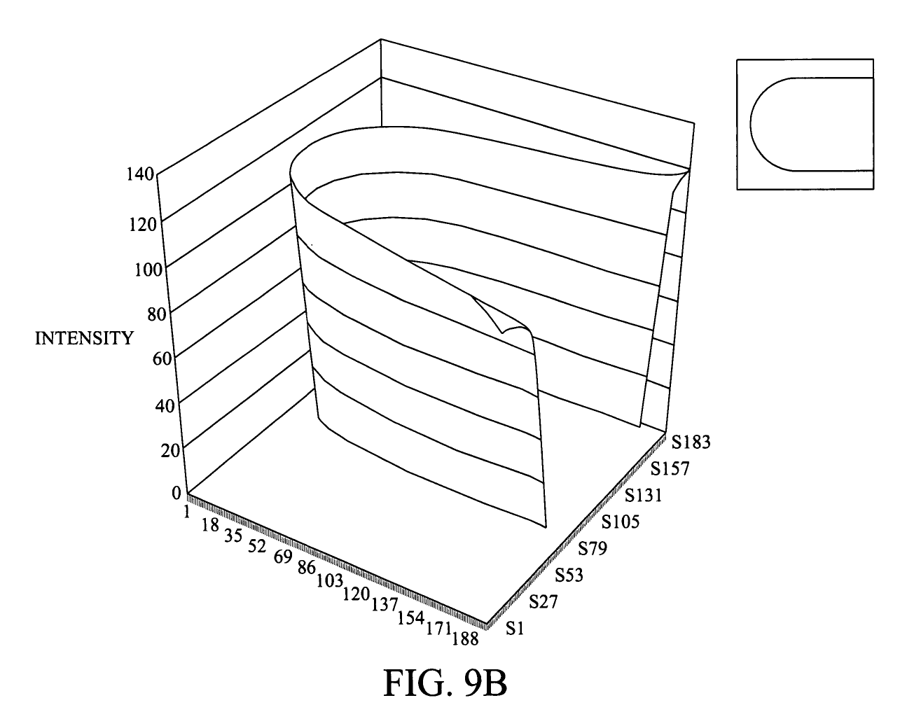

The resulting data, sometimes in the format of a bitmap, may be transferred to the processing system 40 for subsequent processing at block 48. The subsequent processing may involve, for example, edge determination of the hand, shadow determination of the hand, thickness determination of the hand, each of which is based upon a single lighting condition or multiple lighting conditions. The result of the subsequent processing may use the characteristics of the measured hand, such as for example, finger length, knuckle positions, width, area, perimeter, ratios, 3-dimensional thickness, and/or other parameters, to compare against a template associated with user's hands. The system may then permit or deny access at block 49. One potential hand template system is described in U.S. Pat. No. 4,720,869, incorporated by reference herein. An exemplary system configuration for the system is illustrated in FIG. 8. Referring to FIG. 9A, exemplary data illustrating the sharp edges to the data from the light sensitive elements of a finger on the display is shown. Referring to FIG. 9B, the thresholding of the data shown in FIG. 9A illustrates the sharp edges that are obtainable.

The system may likewise be used in conjunction with other systems to provide an additional layer of security. For example, the display may include an associated card reader, RF identification badge reader, handwriting recognition software (which may be sensed by the display itself, if desired), user entered PIN/password, other biometric techniques, etc.

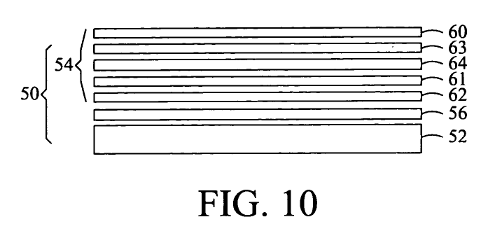

Referring to FIG. 10, a liquid crystal display (LCD) 50 (indicated by a bracket) comprises generally, a backlight 52 and a light valve 54 (indicated by a bracket). Since liquid crystals do not emit light, most LCD panels are backlit with fluorescent tubes or arrays of light-emitting diodes (LEDs) that are built into the sides or back of the panel. To disperse the light and obtain a more uniform intensity over the surface of the display, light from the backlight 52 typically passes through a diffuser 56 before impinging on the light valve 54. For light sources on the edges a light guide is used together with the diffuser 56.

The transmittance of light from the backlight 52 to the eye of a viewer 58, observing an image displayed on the front of the panel, is controlled by the light valve 54. The light valve 54 normally includes a pair of polarizers 60 and 62 separated by a layer of liquid crystals 64 contained in a cell gap between glass or plastic plates, and the polarizers. Light from the backlight 52 impinging on the first polarizer 62 comprises electromagnetic waves vibrating in a plurality of planes. Only that portion of the light vibrating in the plane of the optical axis of the polarizer passes through the polarizer. In an LCD light valve, the optical axes of the first 62 and second 60 polarizer are typically arranged at an angle so that light passing through the first polarizer would normally be blocked from passing through the second polarizer in the series. However, the orientation of the translucent crystals in the layer of liquid crystals 64 can be locally controlled to either “twist” the vibratory plane of the light into alignment with the optical axes of the polarizer, permitting light to pass through the light valve creating a bright picture element or pixel, or out of alignment with the optical axis of one of the polarizes, attenuating the light and creating a darker area of the screen or pixel.

The surfaces of the a first glass substrate 61 and a second glass substrate 63 form the walls of the cell gap are buffed to produce microscopic grooves to physically align the molecules of liquid crystal 64 immediately adjacent to the walls. Molecular forces cause adjacent liquid crystal molecules to attempt to align with their neighbors with the result that the orientation of the molecules in the column of molecules spanning the cell gap twist over the length of the column. Likewise, the plane of vibration of light transiting the column of molecules will be “twisted” from the optical axis of the first polarizer 62 to a plane determined by the orientation of the liquid crystals at the opposite wall of the cell gap. If the wall of the cell gap is buffed to align adjacent crystals with the optical axis of the second polarizer, light from the backlight 52 can pass through the series of polarizers 60 and 62 to produce a lighted area of the display when viewed from the front of the panel (a “normally white” LCD).

To darken a pixel and create an image, a voltage, typically controlled by a thin film transistor, is applied to an electrode in an array of transparent electrodes deposited on the walls of the cell gap. The liquid crystal molecules adjacent to the electrode are attracted by the field produced by the voltage and rotate to align with the field. As the molecules of liquid crystal are rotated by the electric field, the column of crystals is “untwisted,” and the optical axes of the crystals adjacent to the cell wall are rotated progressively out of alignment with the optical axis of the corresponding polarizer progressively reducing the local transmittance of the light valve 54 and attenuating the luminance of the corresponding pixel. In other words, in a normally white twisted nematic device there are generally two modes of operation, one without a voltage applied to the molecules and one with a voltage applied to the molecules. With a voltage applied (e.g., driven mode) to the molecules the molecules do not rotate their polarization axis which results in inhibiting the passage of light to the viewer. Similarly, without a voltage applied (e.g., non-driven mode) the polarization axis is rotated so that the passage of light is not inhibited to the viewer.

Conversely, the polarizers and buffing of the light valve can be arranged to produce a “normally black” LCD having pixels that are dark (light is blocked) when the electrodes are not energized and light when the electrodes are energized. Color LCD displays are created by varying the intensity of transmitted light for each of a plurality of primary color (typically, red, green, and blue) sub-pixels that make up a displayed pixel. Generally, the color filters are on the opposite plate from the light valve aligned with the sub-pixel geometry.

The aforementioned example was described with respect to a twisted nematic device. However, this description is only an example and other devices may likewise be used, including but not limited to, multi-domain vertical alignment, patterned vertical alignment, in-plane switching, and super-twisted nematic type LCDs. In addition other devices, such as for example, plasma displays, organic displays, active matrix organic light emitting display, electroluminescent displays, liquid crystal on silicon displays, reflective liquid crystal devices may likewise be used. For such displays the light emitting portion of the display, or portion of the display that permits the display of selected portions of light may be considered to selectively cause the pixels to provide light.

For an active matrix LCD (AMLCD) the inner surface of the second glass substrate 63 is normally coated with a continuous electrode while the first glass substrate 61 is patterned into individual pixel electrodes. The continuous electrode may be constructed using a transparent electrode, such as indium tin oxide. The first glass substrate 61 may include thin film transistors (TFTs) which act as individual switches for each pixel electrode (or group of pixel electrodes) corresponding to a pixel (or group of pixels). The TFTs are addressed by a set of multiplexed electrodes running along the gaps between the pixel electrodes. Alternatively the pixel electrodes may be on a different layer from the TFTs. A pixel is addressed by applying voltage (or current) to a selected line, which switches the TFT on and allows charge from the data line to flow onto the rear pixel electrodes. The combination of voltages between the front electrode and the pixel electrodes sets up a voltage across the pixels and turns the respective pixels on. The thin-film transistors are typically constructed from amorphous silicon, while other types of switching devices may likewise be used, such as for example, metal-insulator-metal diode and polysilicon thin-film transistors. The TFT array and pixel electrodes may alternatively be on the top of the liquid crystal material. Also, the continuous electrode may be patterned or portions selectively selected, as desired. Also the light sensitive elements may likewise be located on the top, or otherwise above, of the liquid crystal material, if desired.

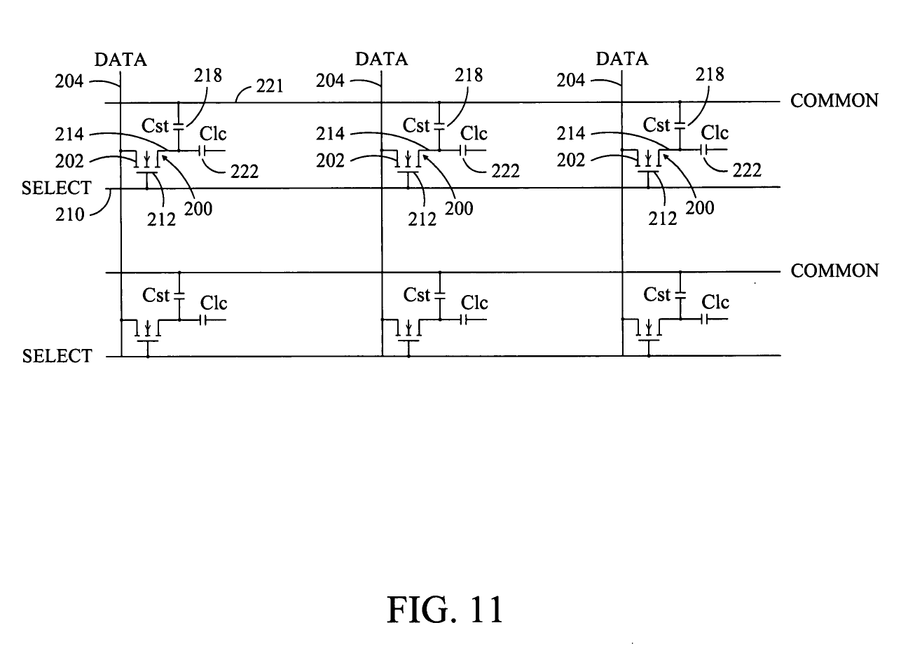

Referring to FIG. 11, the active matrix layer may include a set of data lines and a set of select lines. Normally one data line is included for each column of pixels across the display and one select line is included for each row of pixels down the display, thereby creating an array of conductive lines. To load the data to the respective pixels indicating which pixels should be illuminated, normally in a row-by-row manner, a set of voltages are imposed on the respective data lines 204 which imposes a voltage on the sources 202 of latching transistors 200. The selection of a respective select line 210, interconnected to the gates 212 of the respective latching transistors 200, permits the voltage imposed on the sources 202 to be passed to the drain 214 of the latching transistors 200. The drains 214 of the latching transistors 200 are electrically connected to respective pixel electrodes and are capacitively coupled to a respective common line 221 through a respective Cst capacitor 218. In addition, a respective capacitance exists between the pixel electrodes enclosing the liquid crystal material, noted as capacitances Clc 222 (between the pixel electrodes and the common electrode on the color plate). The common line 221 provides a voltage reference. In other words, the voltage data (representative of the image to be displayed) is loaded into the data lines for a row of latching transistors 200 and imposing a voltage on the select line 210 latches that data into the holding capacitors and hence the pixel electrodes.

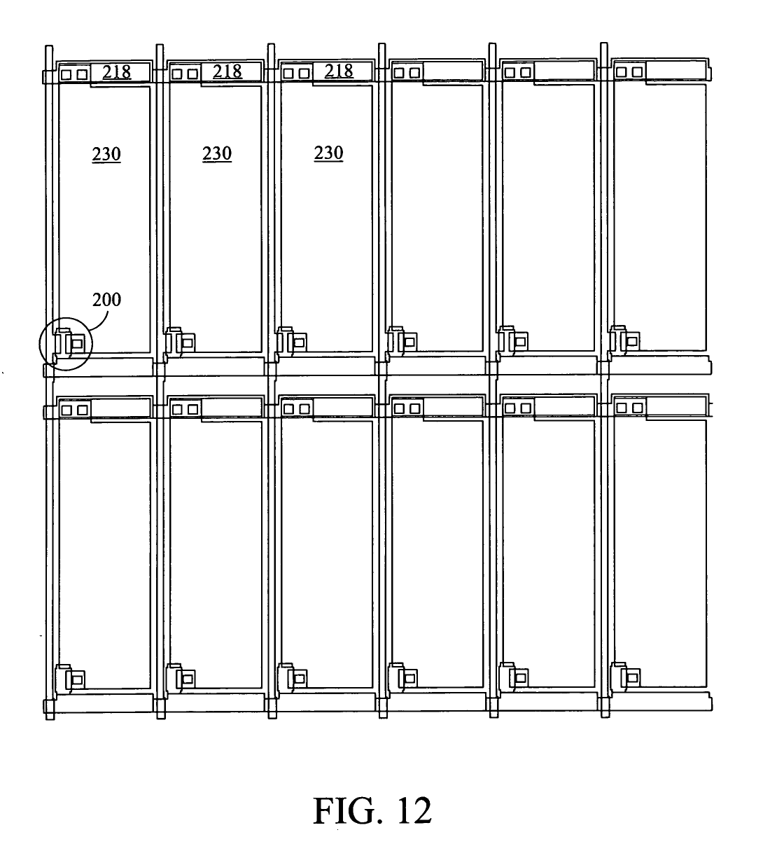

Referring to FIG. 12, a schematic layout is shown of the active matrix layer. The pixel electrodes 230 are generally grouped into a “single” effective pixel so that a corresponding set of pixel electrodes 230 may be associated with respective color filters (e.g., red, green, blue). The latching transistors 200 interconnect the respective pixel electrodes 230 with the data lines and the select line. The pixel electrodes 230 may be interconnected to the common line 221 by the capacitors Cst 218.

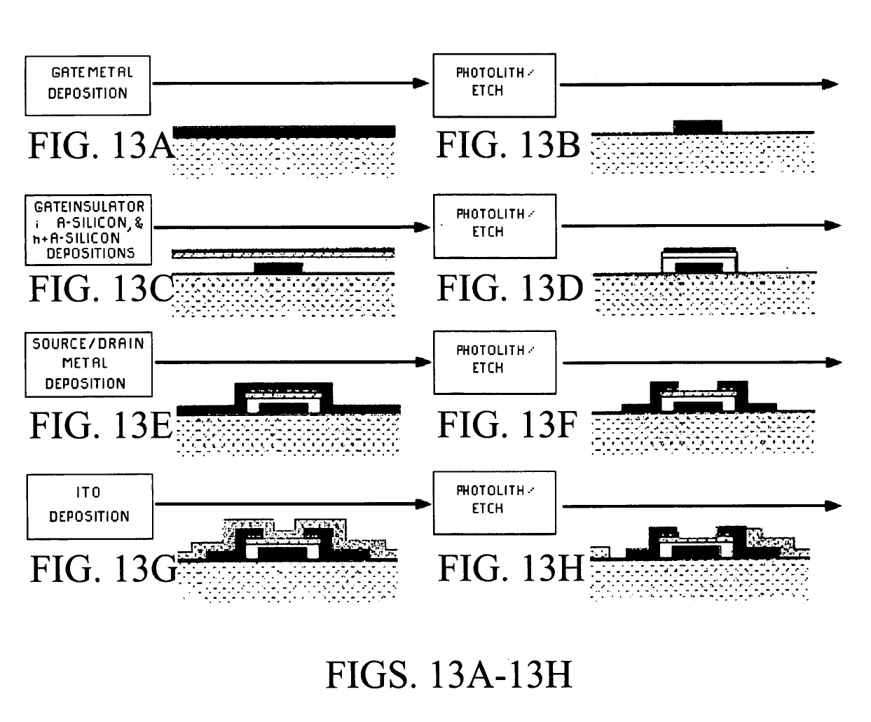

Referring to FIG. 13, the active matrix layer may be constructed using an amorphous silicon thin-film transistor fabrication process. The steps may include gate metal deposition (FIG. 13A), a photolithography/etch (FIG. 13B), a gate insulator and amorphous silicon deposition (FIG. 13C), a photolithography/etch (FIG. 13D), a source/drain metal deposition (FIG. 13E), a photolithography/etch (FIG. 13F), an ITO deposition (FIG. 13G), and a photolithography/etch (FIG. 13H). Other processes may likewise be used, as desired.

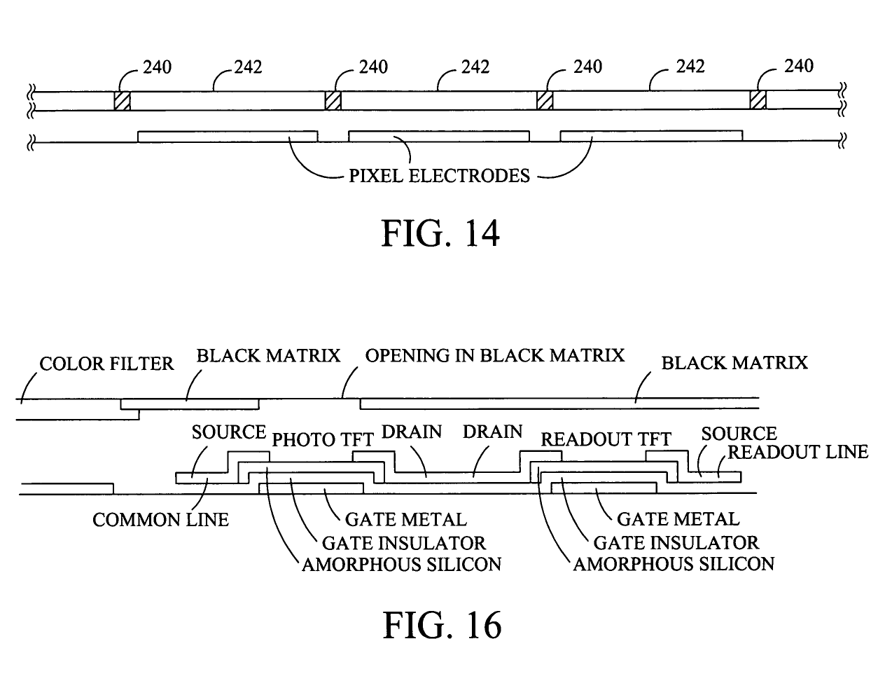

Referring to FIG. 14, with particular attention to the latching transistors of the pixel electrodes, a black matrix 240 is overlying the latching transistors so that significant ambient light does not strike the transistors. Color filters 242 may be located above the pixel electrodes. Ambient light striking the latching transistors results in draining the charge imposed on the pixel electrodes through the transistor. The discharge of the charge imposed on the pixel electrodes results in a decrease in the operational characteristics of the display, frequently to the extent that the display is rendered effectively inoperative. With amorphous silicon transistors being sensitive to light incident thereon, such transistors within the active matrix layer may be used as a basis upon which to detect the existence of or non-existence of ambient light incident thereon (e.g., relative values thereto).

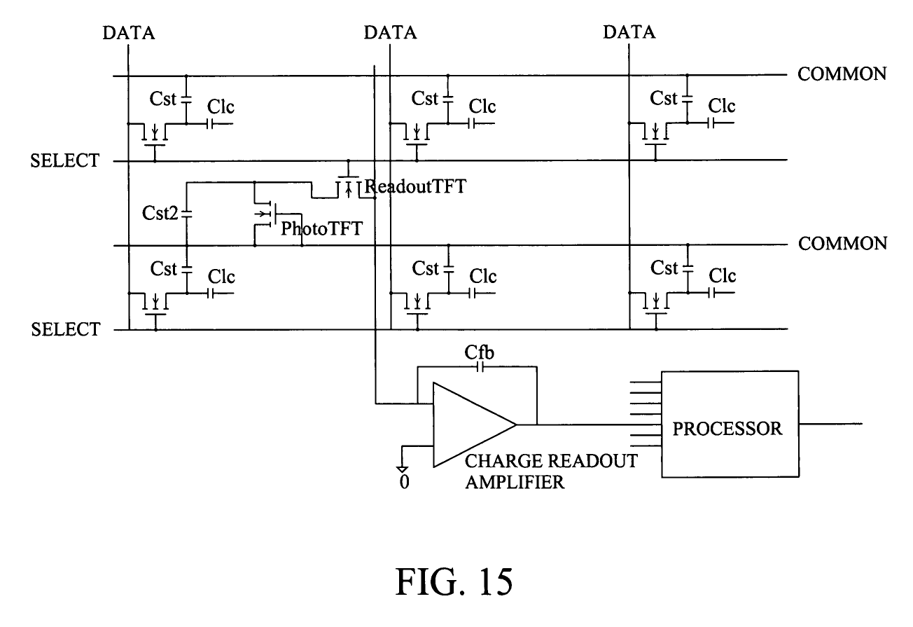

Referring to FIG. 15, a modified active matrix layer may include a photo-sensitive structure or elements. The preferred photo-sensitive structure includes a photo-sensitive thin film transistor (photo TFT) interconnected to a readout thin film transistor (readout TFT). A capacitor Cst2 may interconnect the common line to the transistors. Referring to FIG. 16, a black matrix may be in an overlying relationship to the readout TFT. The black matrix is preferably an opaque material or otherwise the structure of the display selectively inhibiting the transmission of light to selective portions of the active matrix layer. Preferably the black matrix is completely overlying the amorphous silicon portion of the readout TFT, and at least partially overlying the amorphous silicon portion of the readout TFT. Preferably the black matrix is completely non-overlying the amorphous silicon portion of the photo TFT, and at least partially non-overlying the amorphous silicon portion of the photo TFT. Overlying does not necessarily denote direct contact between the layers, but is intended to denote in the general sense the stacked structure of materials. In some embodiments, the black matrix inhibits ambient light from impacting the amorphous silicon portion of the readout TFT to an extent greater than inhibiting ambient light from impacting the amorphous silicon portion of the photo TFT.

As an example, the common line may be set at a negative voltage potential, such as −10 volts. During the previous readout cycle, a voltage is imposed on the select line which causes the voltage on the readout line to be coupled to the drain of the photo TFT and the drain of the readout TFT, which results in a voltage potential across Cst2. The voltage coupled to the drain of the photo TFT and the drain of the readout TFT is approximately ground (e.g., zero volts) with the non-inverting input of the operational amplifier connected to ground. The voltage imposed on the select line is removed so that the readout TFT will turn “off”.

Under normal operational conditions ambient light from the front of the display passes through the black matrix and strikes the amorphous silicon of the photo TFT. However, if a person impedes light from reach the front of the display in a region over the opening in the black matrix or otherwise inhibits the passage of light through the front of the display in a region over the opening in the black matrix, then the photo TFT transistor will be in an “off” state. If the photo TFT is “off” then the voltage across the capacitor Cst2 will not significantly discharge through the photo TFT. Accordingly, the charge imposed across Cst2 will be substantially unchanged. In essence, the voltage imposed across Cst2 will remain substantially unchanged if the ambient light is inhibited from striking the photo TFT.

To determine the voltage across the capacitor Cst2, a voltage is imposed on the select line which causes the gate of the readout TFT to interconnect the imposed voltage on Cst2 to the readout line. If the voltage imposed on the readout line as a result of activating the readout TFT is substantially unchanged, then the output of the operational amplifier will be substantially unchanged (e.g., zero). In this manner, the system is able to determine whether the light to the device has been inhibited.

During the readout cycle, the voltage imposed on the select line causes the voltage on the respective drain of the photo TFT and the drain of the readout TFT to be coupled to the respective readout line, which results in resetting the voltage potential across Cst2. The voltage coupled to the drain of the photo TFT and the drain of the readout TFT is approximately ground (e.g., zero volts) with the non-inverting input of the operational amplifier connected to ground. The voltage imposed on the select line is removed so that the readout TFT will turn “off”. In this manner, the act of reading the voltage simultaneously acts to reset the voltage potential for the next cycle.

Under normal operational conditions ambient light from the front of the display passes through the black matrix and strikes the amorphous silicon of the photo TFT. If a person does not inhibit light from reaching the front of the display in a region over the opening in the black matrix, then the photo TFT transistor will be in an “on” state. If the photo TFT is “on” then the voltage across the capacitor Cst2 will significantly discharge through the photo TFT, which is coupled to the common line. In essence the voltage imposed across Cst2 will decrease toward the common voltage. Accordingly, the charge imposed across Cst2 will be substantially changed in the presence of ambient light. Moreover, there is a substantial difference in the voltage potential across the hold capacitor when the light is not inhibited versus when the light is inhibited.

Similarly, to determine the voltage across the capacitor Cst2, a voltage is imposed on the select line which causes the gate of the readout TFT to interconnect the imposed voltage to the readout line. If the voltage imposed on the readout line as a result of activating the readout TFT is substantially changed or otherwise results in an injection of current, then the output of the operational amplifier will be substantially non-zero. The output voltage of the operational amplifier is proportional or otherwise associated with the charge on the capacitor Cst2. In this manner, the system is able to determine whether the light to the device has been uninhibited, in which case the system will determine that the light has been inhibited at the corresponding portion of the display with the photo TFT.

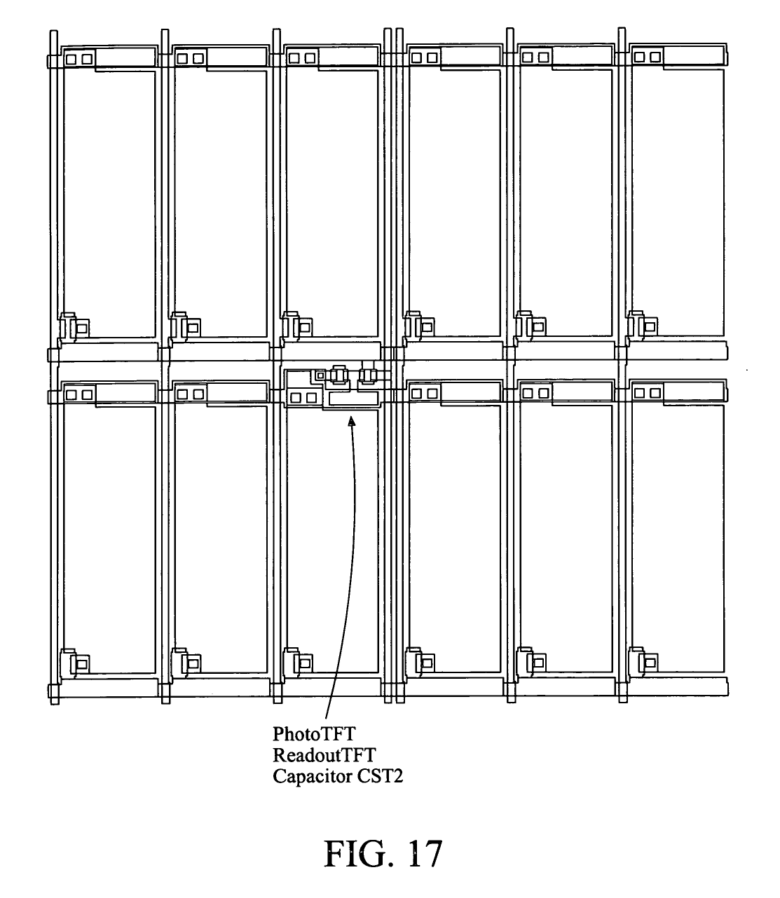

Referring to FIG. 17, a layout of the active matrix layer may include the photo TFT, the capacitor Cst2, the readout TFT in a region between the pixel electrodes. Light sensitive elements are preferably included at selected intervals within the active matrix layer. In addition, the additional photo TFT, readout TFT, and capacitor may be fabricated together with the remainder of the active matrix layer, without the need for specialized processing. Moreover, the complexity of the fabrication process is only slightly increased so that the resulting manufacturing yield will remain substantially unchanged. It is to be understood that other light sensitive elements may likewise be used. In addition, it is to be understood that other light sensitive electrical architectures may likewise be used.

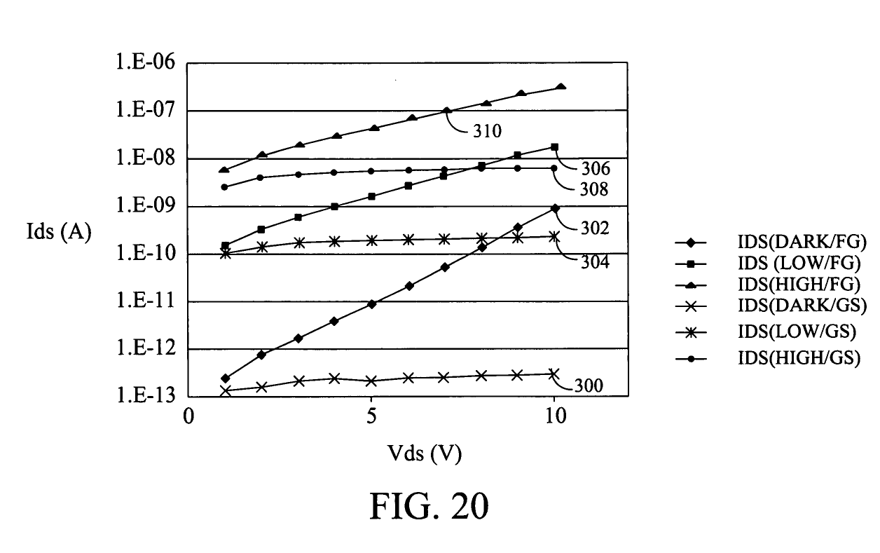

Referring to FIG. 20, a graph of the photo-currents within amorphous silicon TFTs is illustrated. Line 300 illustrates a dark ambient environment with the gate connected to the source of the photo TFT. It will be noted that the leakage currents are low and relatively stable over a range of voltages. Line 302 illustrates a dark ambient environment with a floating gate of the photo TFT. It will be noted that the leakage currents are generally low and relatively unstable over a range of voltages (significant slope). Line 304 illustrates a low ambient environment with the gate connected to the source of the photo TFT. It will be noted that the leakage currents are three orders of magnitude higher than the corresponding dark ambient conditions and relatively stable over a range of voltages. Line 306 illustrates a low ambient environment with a floating gate of the photo TFT. It will be noted that the leakage currents are generally three orders of magnitude higher and relatively unstable over a range of voltages (significant slope). Line 308 illustrates a high ambient environment with the gate connected to the source of the photo TFT. It will be noted that the leakage currents are 4.5 orders of magnitude higher than the corresponding dark ambient conditions and relatively stable over a range of voltages. Line 310 illustrates a high ambient environment with a floating gate of the photo TFT. It will be noted that the leakage currents are generally 4.5 orders of magnitude higher and relatively unstable over a range of voltages (significant slope). With the significant difference between the dark state, the low ambient state, and the high ambient state, together with the substantially flat responses over a voltage range (source-drain voltage), the system may readily process the data in a confident manner, especially with the gate connected to the source.

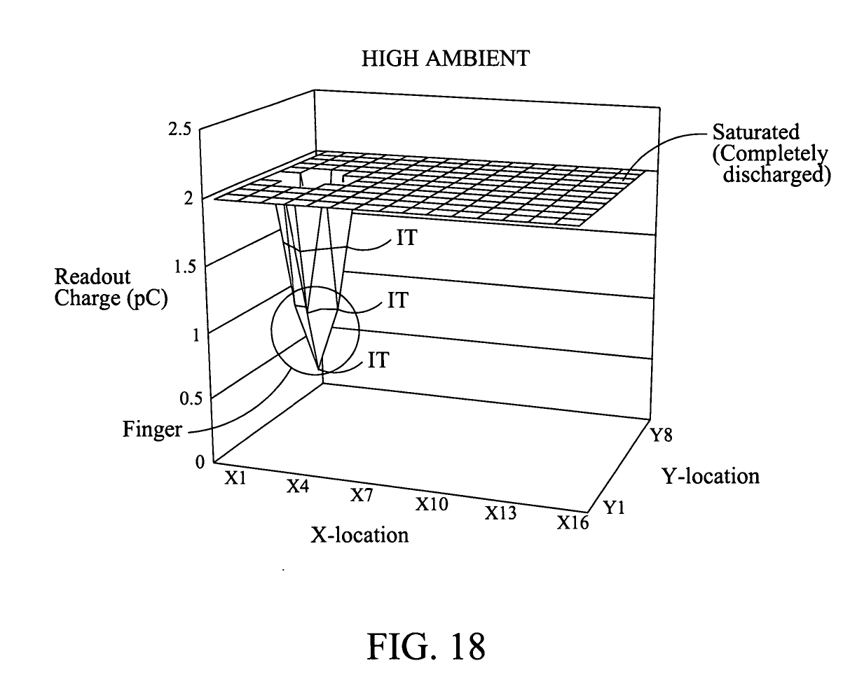

Referring to FIG. 18, under high ambient lighting conditions the photo TFT will tend to completely discharge the Cst2 capacitor to the common voltage, perhaps with an offset voltage because of the photo TFT. In this manner, all of the photo TFTs across the display will tend to discharge to the same voltage level. Those regions with reduced ambient lighting conditions or otherwise where the user blocks ambient light from reaching the display, the Cst2 capacitor will not fully discharge, as illustrated by the downward spike or downward region in the graph. The downward spike in the graph provides location information related to the region of the display that has been light inhibited. In the case of a hand the spike or downward region will be a large region of non-discharge similar to FIG. 9A.

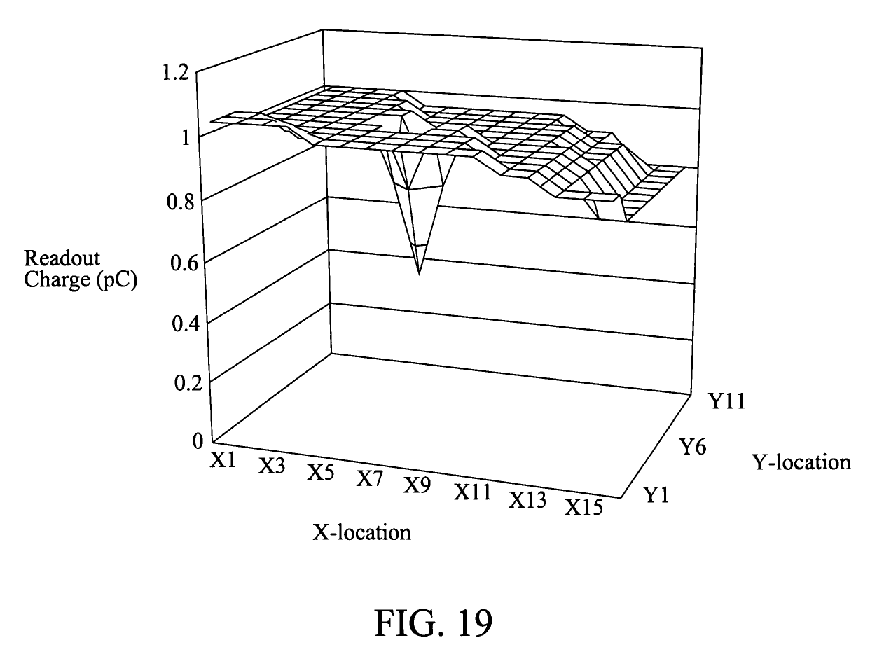

Referring to FIG. 19, under lower ambient lighting conditions the photo TFT will tend to partially discharge the Cst2 capacitor to the common voltage. In this manner, all of the photo TFTs across the display will tend to discharge to some intermediate voltage levels. Those regions with further reduced ambient lighting conditions or otherwise where the user blocks ambient light from reaching the display, the Cst2 capacitor will discharge to a significantly less extent, as illustrated by the downward spike or downward region in the graph. The downward spike or downward region in the graph provides location information related to the region of the display that has been light inhibited. As shown in FIGS. 18 and 19, the region or regions where the user inhibits light from reaching the display may be determined as localized minimums. In other embodiments, depending on the circuit topology, the location(s) where the user inhibits light from reaching the display may be determined as localized maximums or otherwise some measure from the additional components.

In the circuit topology illustrated, the value of the capacitor Cst2 may be selected such that it is suitable for high ambient lighting conditions or low ambient lighting conditions. For low ambient lighting conditions, a smaller capacitance may be selected so that the device is more sensitive to changes in light. For high ambient lighting conditions, a larger capacitance may be selected so that the device is less sensitive to changes in light. In addition, the dimensions of the phototransistor may be selected to change the photo-leakage current. Also, one set of light sensitive elements (e.g., the photo TFT and the capacitance) within the display may be optimized for low ambient lighting conditions while another set of light sensitive elements (e.g., the photo TFT and the capacitance) within the display may be optimized for high ambient lighting conditions. Typically, the data from light sensitive elements for low ambient conditions and the data from light sensitive elements for high ambient conditions are separately processed, and the suitable set of data is selected. In this manner, the same display device may be used for high and low ambient lighting conditions. For example, additional light sources 32, 34 provide high and low ambient lighting conditions. In addition, multiple levels of sensitivity may be provided. It is to be understood that a single architecture may be provided with a wide range of sensitivity from low to high ambient lighting conditions.

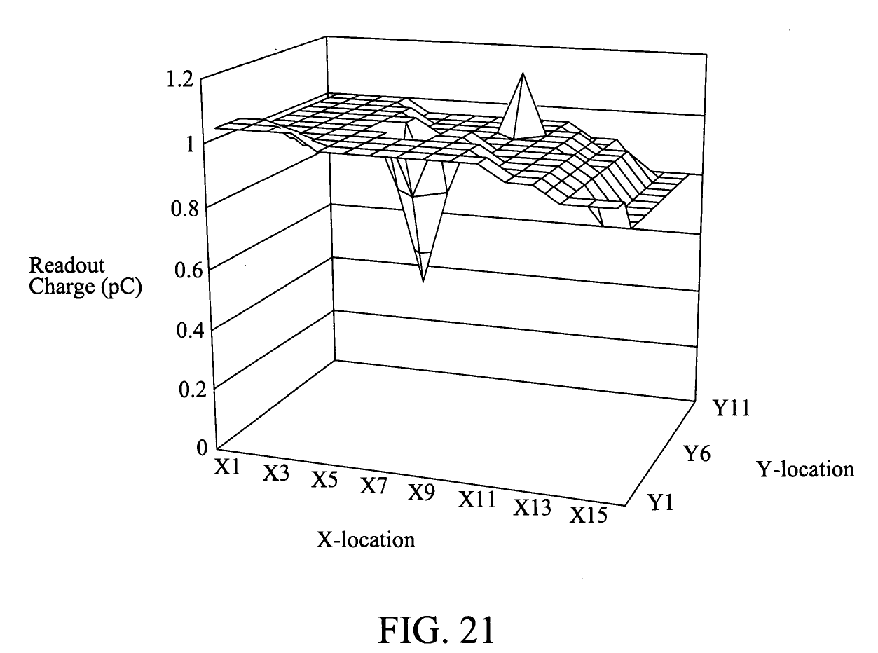

Another structure that may be included is selecting the value of the capacitance so that under normal ambient lighting conditions the charge on the capacitor only partially discharges. With a structure where the capacitive charge only partially discharges, an optical device, such as a lamp 32, 34 might be used to point at the display to further discharge particular regions of the display. In this manner, the region of the display that the optical device remains pointed at may be detected as local maximums (or otherwise). In addition, those regions of the display where light is inhibited will appear as local minimums (or otherwise). This provides the capability of detecting not only the absence of light (e.g., touching the panel) but likewise those regions of the display that have increased light incident thereon. Referring to FIG. 21, a graph illustrates local minimums (upward peaks) from added light and local maximums (downward peaks) from a lack of light. With the ability to detect local minimums and local maximums, the ability to discriminate between regions of the hand (local minimums) and the remainder of the display (local maximums) is increased. In addition, one set of light sensitive elements (e.g., the photo TFT and the capacitance) within the display may be optimized for ambient lighting conditions to detect the absence of light while another set of light sensitive elements (e.g., the photo TFT and the capacitance) within the display may be optimized for ambient lighting conditions to detect the additional light imposed thereon.

It is noted that the teachings herein are likewise applicable to transmissive active matrix liquid crystal devices, reflective active matrix liquid crystal devices, transflective active matrix liquid crystal devices, etc. In addition, the light sensitive elements may likewise be provided within a passive liquid crystal display. The sensing devices may be, for example, photo resistors and photo diodes.

Alternatively, light sensitive elements may be provided between the rear polarizing element and the active matrix layer. In this arrangement, the light sensitive elements are preferably fabricated on the polarizer, or otherwise a film attached to the polarizer. In addition, the light sensitive elements may be provided on a thin glass plate between the polarizer and the liquid crystal material. In addition, the black matrix or otherwise light inhibiting material is preferably arranged so as to inhibit ambient light from striking the readout TFT while free from inhibiting light from striking the photo TFT. Moreover, preferably a light blocking material is provided between the photo TFT and/or the readout TFT and the backlight, such as gate metal, if provided, to inhibit the light from the backlight from reaching the photo TFT and/or the readout TFT.

Alternatively, light sensitive elements may be provided between the front polarizing element and the liquid crystal material. In this arrangement, the light sensitive elements are preferably fabricated on the polarizer, or otherwise a film attached to the polarizer. In addition, the light sensitive elements may be provided on a thin glass plate between the polarizer and the liquid crystal material. The light sensitive elements may likewise be fabricated within the front electrode layer by patterning the front electrode layer and including suitable fabrication techniques. The light sensitive elements may be located behind the color filters so that color effects of the reflected light from the hand maybe determined. This permits color information to be determined regarding the hand. In addition, a black matrix or otherwise light inhibiting material is preferably arranged so as to inhibit ambient light from striking the readout TFT while free from inhibiting light from striking the photo TFT. Moreover, preferably a light blocking material is provided between the photo TFT and/or the readout TFT and the backlight, if provided, to inhibit the light from the backlight from reaching the photo TFT and/or the readout TFT.

Alternatively, light sensitive elements may be provided between the front of the display and the rear of the display, normally fabricated on one of the layers therein or fabricated on a separate layer provided within the stack of layers within the display. In the case of a liquid crystal device with a backlight the light sensitive elements are preferably provided between the front of the display and the backlight material. The position of the light sensitive elements are preferably between (or at least partially) the pixel electrodes, when viewed from a plan view of the display. This may be particularly useful for reflective displays where the pixel electrodes are opaque. In addition for reflective displays, any reflective conductive electrodes should be arranged so that they do not significantly inhibit light from reaching the light sensitive elements. In this arrangement, the light sensitive elements are preferably fabricated on one or more of the layers, or otherwise a plate attached to one or more of the layers. In addition, a black matrix or otherwise light inhibiting material is preferably arranged so as to inhibit ambient light from striking the readout TFT while free from inhibiting light from striking the photo TFT. Moreover, preferably a light blocking material is provided between the photo TFT and/or the readout TFT and the backlight, if provided, to inhibit the light from the backlight from reaching the photo TFT and/or the readout TFT.

In many applications it is desirable to modify the intensity of the backlight for different lighting conditions. For example, in dark ambient lighting conditions it may be beneficial to have a dim backlight. In contrast, in bright ambient lighting conditions it may be beneficial to have a bright backlight. The integrated light sensitive elements within the display stack may be used as a measure of the ambient lighting conditions to control the intensity of the backlight without the need for an additional external photo-sensor. One light sensitive element may be used, or a plurality of light sensitive element may be used together with additional processing, such as averaging.

In one embodiment, the readout line may be included in a periodic manner within the display sufficient to generally identify the location of the hand. For example the readout line may be periodically added in a spaced apart manner across the display. Spacing the readout lines at a significant number of pixels apart result in a display that nearly maintains its previous brightness because most of the pixel electrodes have an unchanged size. However, after considerable testing it was determined that such periodic spacing results in a noticeable non-uniform gray scale because of differences in the size of the active region of the pixel electrodes. One potential resolution of the non-uniform gray scale is to modify the frame data in a manner consistent with the non-uniformity, such as increasing the gray level of the pixel electrodes with a reduced size or otherwise reducing the gray levels of the non-reduced size pixel electrodes, or a combination thereof. While a potential resolution, this requires additional data processing which increases the computational complexity of the system.

A more desirable resolution of the non-uniform gray scale is to modify the display to include a readout line in a manner consistent with the pixel electrode pattern of the display (red pixel, green pixel, blue pixel). The patten of readout lines is preferably included over a majority of the display. The resulting display may include more readout lines than are necessary to accurately determine the location of the edges of the hand. To reduce the computational complexity of the display, a selection of the readout lines may be free from interconnection or otherwise not operationally interconnected with readout electronics. In addition, to further reduce the computational complexity of the display and to increase the size of the pixel electrodes, the readout lines not operationally interconnected with readout electronics may likewise be free from an associated light sensitive element. In other words, additional non-operational readout lines may be included within the display to provide a gray scale display with increased uniformity. In an alternative embodiment, one or more of the non-operational readout lines may be replaced with spaces. In this manner, the gray scale display may include increased uniformity, albeit with additional spaces within the pixel electrode matrix.

The electrode corresponding to “blue” light does not contribute to the overall white transmission to the extent that the “green” or “red” electrodes. Accordingly, the system may be designed in such a manner that the light sensitive elements are associated with the “blue” electrodes to an extent greater than their association with the “green” or “red” electrodes. In this manner, the “blue” pixel electrodes may be decreased in size to accommodate the light sensitive elements while the white transmission remains substantially unchanged. Experiments have shown that reducing the size of the “blue” electrodes to approximately 85% of their original size, with the “green” and “red” electrodes remaining unchanged, results in a reduction in the white transmission by only about 3 percent.

While such an additional set of non-operational readout lines provides for increased uniform gray levels, the reduction of pixel apertures results in a reduction of brightness normally by at least 5 percent and possibly as much as 15 percent depending on the resolution and layout design rules employed. In addition, the manufacturing yield is decreased because the readout line has a tendency to short to its neighboring data line if the processing characteristics are not accurately controlled.

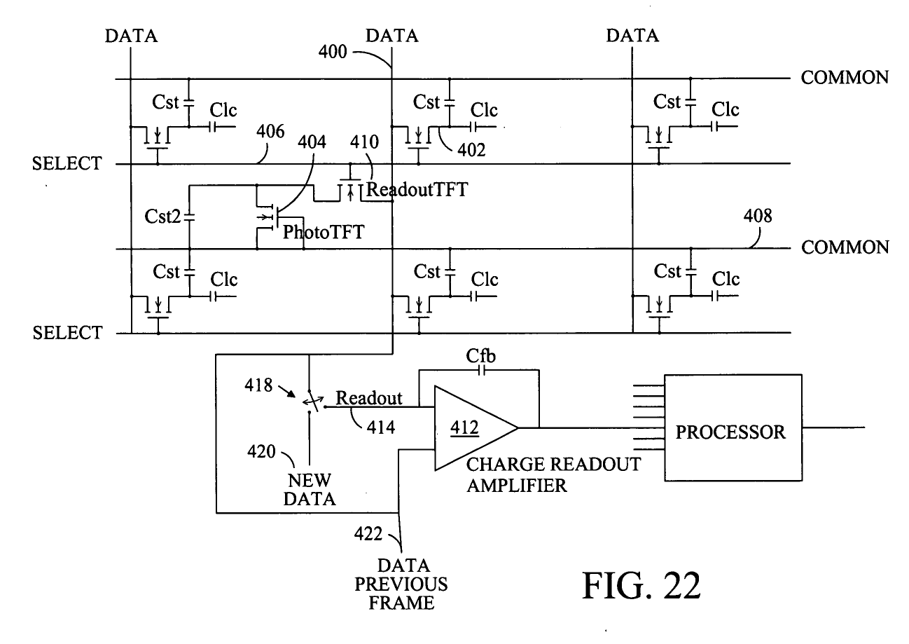

Referring to FIG. 22, to increase the potential manufacturing yield and the brightness of the display, the readout of the photo-sensitive circuit and the writing of data to the pixels may be combined on the same bus line, or otherwise a set of lines that are electrically interconnected to one another. To facilitate the use of the same bus line, a switch 418 may select between providing new data 420 to the selected pixels and reading data 414 from the selected pixels. With the switch 418 set to interconnect the new data 420 with the selected pixels, the data from a frame buffer or otherwise the video data stream may be provided to the pixels associated with one of the select lines. Multiple readout circuits may be used, or one or more multiplexed readout circuits maybe used. For example, the new data 420 provided on data line 400 may be 4.5 volts which is latched to the pixel electrode 402 and the photo TFT 404 by imposing a suitable voltage on the select line 406. In this manner, the data voltage is latched to both the pixel electrode and a corresponding photo-sensitive circuit.

The display is illuminated in a traditional manner and the voltage imposed on the photo TFT 404 may be modified in accordance with the light incident on the photo-sensitive circuit, as previously described. In the topology illustrated, the photo TFT 404 is normally a N-type transistor which is reverse biased by setting the voltage on the common line 408 to a voltage lower than an anticipated voltage on the photo TFT 404, such as −10 or −15 volts. The data for the current frame may be stored in a frame buffer for later usage. Prior to writing the data for another frame, such as the next frame, the data (e.g., voltage) on the readout TFT 410 is read out. The switch 418 changes between the new data 420 to the readout line 414 interconnected to the charge readout amplifier 412. The select line 406 is again selected to couple the remaining voltage on the photo TFT 404 through the readout TFT 410 to the data line 400. The coupled voltage (or current) to the data line 400 is provided as an input to the charge readout amplifier 412 which is compared against the corresponding data from the previous frame 422, namely, the voltage originally imposed on the photo TFT 404. The difference between the readout line 414 and the data from the previous frame 422 provides an output to the amplifier 412. The output of the amplifier 412 is provided to the processor. The greater the drain of the photo TFT 404, normally as a result of sensing light, results in a greater output of the amplifier 412. Referring to FIG. 23, an exemplary timing for the writing and readout on the shared data line 400 is illustrated.

At low ambient lighting conditions and at dark lighting conditions, the integrated optical hand sensing panel is not expected to operate well to the absence of light because of the hand because there will be an insufficient (or none) difference between the signals from the surrounding area and the light inhibited area. To alleviate the inability to effectively sense at the low and dark ambient lighting conditions an additional light 32, 34 may be used (e.g., light source), as previously described. The light source may be operably interconnected to the display such as by a wire or wireless communication link. With the light source operably interconnected to the display the intensity of the light source may be controlled, at least in part, by feedback from the photo-sensitive elements or otherwise the display. When the display determines that sufficient ambient light exists, such as ambient light exceeding a threshold value, the light source is turned “off”. When the display determines that insufficient ambient light exists, such as ambient light failing to exceed a threshold value, the light source is turned “on”. This permits the display to be operated in dark ambient lighting conditions or by feedback from the display. In addition, the intensity of the light from the light source may be varied, such as step-wise, linearly, non-linearly, or continuously, depending upon the ambient lighting conditions. Alternatively, the light source may include its own ambient light detector so that feedback from the display is unnecessary and likewise communication between the light source and the display may be unnecessary.

While using light from an external light source while beneficial it may still be difficult to accurately detect the light inhibited location because of background noise within the system and variable lighting conditions. By providing light during different frames, such as odd frames or even frames, or odd fields or even fields, or every third frame, or during selected frames, a more defined differential signal between the frames indicates the light inhibited region. In essence, the light may be turned on and off in some manner, such as blinking at a rate synchronized with the display line scanning or frames. An exemplary timing for an odd/even frame arrangement is shown in FIG. 24. In addition, the illumination of some types of displays involves scanning the display in a row-by-row manner. In such a case, the differential signal may be improved by modifying the timing of the light pulses in accordance with the timing of the gate pulse (e.g., scanning) for the respective pixel electrodes. For example, in a top-down scanning display the light pulse should be earlier when the light source is directed toward the top of the display as opposed to the bottom of the display. The synchronization may be based upon feedback from the display, if desired.

In one embodiment, the light source may blink at a rate synchronized with the display line scanning. For example, the light source may use the same driver source as the image pixel electrodes. In another embodiment the use of sequential (or otherwise) frames may be subtracted from one another which results in significant different between signal and ambient conditions. Preferably, the light sensitive elements have a dynamic range greater than 2 decades, and more preferably a dynamic range greater than 4 decades. If desired, the system may use two sequential fields of scanning (all lines) subtracted from the next two fields of scanning (all lines) so that all the lines of the display are used.

If the light source providing light to the display was modulated in some fashion an improvement in signal detection may be achieved. For example, a light source associated therewith may be modulated in accordance with the frame rate of the display. With a frame rate of 60 hertz the light source may be modulated at a rate of 30 hertz, 20 hertz, 10 hertz, etc. which results in additional light periodically being sensed by the light sensitive elements. Preferably, the light source is modulated (“blinked”) at a rate synchronized with the display line scanning, and uses the same raw drivers as the image thin-film transistors. The resulting data may be processed in a variety of different ways.

In one embodiment, the signals from the light sensitive elements are used, as captured. The resulting improvement in signal to background ratio is related to the pulse length of the light relative to the frame time.

In another embodiment, multiple frames are compared against one another to detect the presence and absence of the additional light resulting from the modulation. In the case of subsequent frames (sequential or non-sequential), one without additional light and one with additional light, the data from the light sensitive elements may be subtracted from one another. The improvement in signal to background ratio is related to the periodic absence of the additional light. In addition, this processing technique is especially suitable for low ambient lighting and high ambient lighting conditions. Preferably the dynamic range of the sensors is at least 4 decades, and two sequential frames with additional light and two sequential frames without additional light are used so that all of the scanning lines are encompassed. When the system charges a sensor it takes a whole frame for it to discharge by the light. Since the first line will start at time zero and take a frame time, the last line will be charged after almost a frame and will take another frame time to discharge. Therefore, the system should preferably use two frames with additional illumination and then two frames without additional illumination.

It is to be understood that the external lights may be modified to influence lighting conditions. In addition, the light output of the backlight of the display may be modified to assist in data acquisition. For example, the intensity of the backlight may be modified during different time periods, different frames, or otherwise. In addition, the backlight may be turned off during different time periods, different frames, or otherwise, if desired.

All references cited herein are hereby incorporated by reference.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A display comprising:
(a) said display including light sensitive elements within the area illuminated by said display;
(b) a processing device receiving information from said light sensitive elements responsive to said light sensitive elements sensing a portion of a hand;
(c) said processing device determining whether said portion of said hand matches a known hand;
(d) wherein said portion of said hand includes at least two fingers of said hand.

2. The display of claim 1 wherein said known hand is characterized by a template.

3. The display of claim 1 wherein said light sensitive elements are photo-transistors.

4. The display of claim 1 wherein said display is portable.

5. The display of claim 1 wherein said processing device is within a housing surrounding said display.

6. The display of claim 1 wherein said processing device is a laptop computer.

7. The display of claim 1 wherein said processing device is a personal computer.

8. The display of claim 1 further comprising a first light source external to said display and illuminating said display.

9. The display of claim 8 further comprising a second light source external to said display and illuminating said display.

10. The display of claim 8 wherein said first light source selectively illuminates said display.

11. The display of claim 10 wherein said selective illumination increases the ability to sense said portion of said hand.

12. The display of claim 11 wherein said selective illumination increases the contract of said display.

13. The display of claim 8 wherein said processing device determines 3-dimensional characteristics of said portion of said hand.

14. The display of claim 1 wherein said display is a liquid crystal device.

15. A computer comprising:
(a) a housing enclosing said computer;
(b) a display movably connected to said housing and operationally connected to said computer;
(c) said display including light sensitive elements within the area illuminated by said display;
(d) selectively permitting access to an associated system based upon sensing at least a portion of a hand by said light sensitive elements;
(e) wherein said portion of said hand includes at least two fingers of said hand.

16. The computer of claim 15 wherein said display is a liquid crystal device.

17. The computer of claim 15 wherein said housing is portable.

18. The computer of claim 15 wherein said hand is characterized by a template.

19. The computer of claim 15 wherein said light sensitive elements are photo-transistors.

20. The computer of claim 15 wherein said computer is a laptop computer.

21. The computer of claim 15 wherein said computer is a personal computer.

22. The computer of claim 15 further comprising a first light source external to said display and illuminating said display.

23. The computer of claim 22 further comprising a second light source external to said display and illuminating said display.

24. The computer of claim 22 wherein said first light source selectively illuminates said display.

25. The computer of claim 24 wherein said selective illumination increases the ability to sense said portion of said hand.

26. The computer of claim 25 wherein said selective illumination increases the contract of said display.

27. The computer of claim 15 wherein said processing device determines 3-dimensional characteristics of said portion of said hand.

28. The computer of claim 15 wherein said display is a liquid crystal device.

29. The computer of claim 15 wherein said display includes a set of photo-transistors between a front surface and a light valve.

30. A hand recognition system comprising:
(a) a display;
(b) a sensing system for sensing at least a portion of a hand;
(c) said display indicating to a user of said hand recognition system the following:
(i) an identification that said display is used for hand recognition;
(ii) an indication of where to locate said hand for said hand recognition system;
(iii) an indication of the results of sensing said at least a portion of said hand by said hand recognition system;
(d) wherein said portion of said hand includes at least two fingers of said hand.

31. The hand recognition system of claim 30 wherein said sensing system includes light sensitive elements within said display.

32. The hand recognition system of claim 31 wherein said light sensitive elements sense at least a portion of said hand.

33. A computer comprising:
(a) a housing enclosing said computer;
(b) a display movably connected to said housing and operationally connected to said computer;
(c) said display including light sensitive elements within the area illuminated by said display;
(d) selectively permitting access to an associated system based upon sensing at least a portion of a hand by said light sensitive elements;
(e) wherein said display includes a set of photo-transistors between a front surface and a light valve.
